(19) United States
(12) Patent Application Publication
(10) Pub. No.: US 2005/0230998 A1
(43) Pub. Date: Oct. 20, 2005

(54) Detachable glare shields for automotive sun visors

(76) Inventor: Jun S. Im, Troy, MI (US)

Correspondence Address: HARNESS, DICKEY & PIERCE, P.L.C., P.O. BOX 828, BLOOMFIELD HILLS, MI, 48303, US

(21) Appl. No.: 11/081,051

(22) Filed: Mar. 15, 2005

Related U.S. Application Data
(60) Provisional application No. 60/562,834, filed on Apr. 14, 2004.

(51) Int. Cl. B60J 3/00

(52) U.S. Cl. 296/97.6

(57) ABSTRACT

A glare shield system is provided for detachable connection to a conventional automotive vehicle sun visor. The glare shield is formed of an elongated, translucent, glare-reducing material. The shield is pivotally connected to the lower edge portion of the sun visor by a bracket formed of an elongated strip having springy clips on its opposite ends for attaching and detaching the bracket to the sun visor. A pair of spaced-apart lugs are formed on the opposite ends of the bracket strip and provide sockets to receive a pair of laterally extending pivot pins formed on the opposite ends of the glare shield. Thus, the glare shield may be pivoted, relative to the bracket, into a non-use position wherein it overlaps the bracket strip and is held by a suitable latch. Alternatively, the shield may be pivoted downwardly, relative to the bracket, into a position where it extends downwardly from the visor to obstruct glare. The shield has a concavely curved strip along its upper edge so that when it is pivoted into its use position, the curved strip receives light rays from traffic signals and displays images of the signals to the driver located within the vehicle. As an alternative, the glare shield may be mounted within a pocket formed within a sun visor. It may be slid into the pocket for storage or downwardly out of the pocket for use. It too has a transversely curved strip along its upper edge which would be exposed when the shield is in use for transmitting an image of a traffic signal to the driver of the vehicle.

### CROSS-REFERENCE TO RELATED APPLICATIONS

This application is based upon, and incorporates herein the disclosure of, Provisional Application Ser. No. 60/562,834 filed Apr. 14, 2004 and entitled “Low-Profile Detachable Glare Shields For Automotive Sun Visors.”

### BACKGROUND OF THE INVENTION

This invention relates to glare shields which are attached to conventional automotive vehicle sun visors for reducing the glare of sunlight beneath the lower edge of the visor. Conventional sun visors which are used on virtually all automotive vehicles, in general, comprise a horizontally elongated panel attached above the upper edge of the vehicle windshield in front of the driver or in front of a passenger sitting next to the driver. Typically, the visor attachments are formed of a rod connected to the visor along the upper, elongated edge of the visor and pivotally attached, by a suitable bracket, to the vehicle structure adjacent to the windshield. Thus, the visor may be pivoted upwardly into a non-use position, where it is generally parallel to the roof of the vehicle or, alternatively, may be pivoted downwardly into a roughly vertical plane, where it overlaps the upper portion of the windshield for blocking the glare of sun rays or oncoming lights. Such visors may also be pivoted into a position where they overlap the upper portion of the adjacent side window next to the driver or, alternatively, if the visor is mounted at the passenger side of the vehicle, to overlap the side window next to the passenger side of the vehicle.

Conventional visors obscure only a narrow portion of the upper edge of the windshield, leaving the remainder of the windshield free of obstruction. However, in many instances, where the sun is low in the sky, there may be considerable glare below the lower edge of the sun visor that affects the driver or passenger. Hence, glare shields formed of translucent or tinted plastic panels have been attached to the lower edge of the vehicle sun visor to provide shielding of the sun's rays or other glare beneath the lower edge of the visor. Such glare shields have been fastened to the lower edge of the sun visor by suitable fasteners that permit attaching or detaching the shield to the visor.

When glare shields are used, a common problem arises where the driver approaches a traffic signal light that is located generally higher than and ahead of the vehicle. The glare shield and visor combination make it difficult for the driver to see the light and to observe the usual changeovers between the green go signal, the yellow caution signal and the red stop signal. Frequently, for a driver to see a traffic light ahead, when the glare shield and the visor are positioned in front of the driver and over the upper portion of the windshield, the driver must look underneath or around the sides of the glare shield and visor or otherwise move the visor out of the use position to clear the view of the traffic light.

Moreover, with typical glare shields, that are attached to the lower edge of a sun visor, a gap appears between the visor and shield through which sun glare impinges upon the driver's eyes. Hence, it is desirable to have a glare shield which not only prevents glare immediately beneath the visor, but also precludes glare in any gap between the lower edge of the visor and the upper edge of the shield. Thus, the way that the shield is attached to the visor should prevent glare between the two.

Since glare shields typically are made of relatively inexpensive plastic and are low-cost items which are necessary only in some places during times of the year when glare is a problem, it is necessary to form glare shields in such a way that they are inexpensive and, also, easily attachable and detachable from the permanently installed vehicle sun visor.

An example of a prior sun visor and glare shield combination is illustrated in the patent to Forrest E. Holladay, U.S. Pat. No. 3,837,703 issued Sep. 24, 1974 for “Glare Shields.” This patent illustrates one form of a translucent glare shield, which filters sunlight or glare from the driver, attached by clips to the vehicle sun visor for removal and installation when desired. While this kind of glare shield appears to be useful in reducing glare occurring beneath the sun visor when the shield is pivoted into a position beneath the sun visor, its attachment devices and its construction would interfere with a clear, unobstructed view of traffic lights. The present invention relates to a detachable system and a shield construction which substantially improves visibility and user ease of attaching and operating a glare shield.

The present invention addresses these and other problems relating to prior glare shields as will be described below.

### SUMMARY OF THE INVENTION

This invention relates to a glare shield assembly comprising a bracket which supports a glare shield beneath the lower edge of a conventional sun visor. The shield is pivotable into a non-use position parallel to the sun visor when not needed and, alternatively, into a use position in which it extends beneath the sun visor for reducing glare. Preferably, the shield is connected to the bracket by pivots located on the opposite ends of the shield and located on the bracket beneath the lower edge of the visor. When the shield is in its use position, a portion of the shield covers the space or gap which would otherwise appear between the lower edge of the sun visor and the shield. Moreover, it is contemplated to form the upper edge of the glare shield with a concave strip construction which will display an image of traffic lights located in front of the vehicle to avoid the need to move the glare shield and the sun visor or to physically move around the shield and visor to obtain an unobstructed view of the lights.

Another object of this invention is to provide a glare shield assembly which is extremely inexpensive and is very easy for a driver to attach or remove the shield when desired.

A further object of this invention is to provide a modified, combined glare shield and sun visor in which the glare shield is normally stored within the visor, out of the way, and is easily moved, manually, into a use position beneath the sun visor or retracted into the visor for non-use, as desired by the driver.

These and other objects and advantages of this invention will become apparent upon reading the following description, of which the attached drawings form a part.

### DESCRIPTION OF THE DRAWINGS

FIG. 1 is a perspective, rear view illustrating the glare shield secured to the lower edge portion of a sun visor and in its use position.

FIG. 2 is a perspective view of the glare shield assembly with the glare shield swung upwardly into its non-use, storage position.

FIG. 3 is an end view taken in the direction of arrows 3-3 of FIG. 1 illustrating the glare shield swung downwardly into its operative or use position and showing, in dotted lines, the shield pivoted at an angle relative to the lower edge of the sun visor.

FIG. 4 is a perspective view, to a reduced scale, of the glare shield and its attachment bracket separated.

FIG. 5 is a perspective, front view, that is, the view facing the windshield of a vehicle, of the assembled support bracket and glare shield and with the glare shield in lowered, or use, position.

FIG. 6 illustrates a view similar to FIG. 5, but to a smaller scale and showing the glare shield disassembled from its support bracket.

FIG. 7 is an enlarged end view showing the bracket attached to the lower end of a visor (shown in dotted lines), with the shield pivoted into its upward, stored position.

FIG. 8 is a view similar to FIG. 7, but showing the sun visor (in dotted lines) and the glare shield arranged generally horizontally, that is, in a non-use position where the visor is arranged generally parallel to the roof of the vehicle so that it does not obstruct any portion of the windshield.

FIG. 9 is a rear, elevational view of the bracket and shield assembly with the shield pivoted downwardly in its normal use position and showing the axis of pivoting in a dotted line.

FIG. 10 is a cross-sectional view taken in the direction of arrows 10-10 of FIG. 9, but illustrating the shield pivoted into its upward, storage position, and held by the latch on the bracket.

FIG. 11 is an enlarged, schematic view, illustrating the rays of a traffic light passing to, and then through, the curved upper edge strip formed on the shield so that the image of the light is visible to the driver's eye.

FIG. 12 illustrates a modification wherein the shield is stored within a pocket provided in the sun visor.

FIG. 13 is a fragmentary, perspective view showing the connection between the shield, arranged within the visor and an edge groove formed in the interior of the visor for guiding the pivot pin of the shield.

FIG. 14 is an elevational, cross-sectional view illustrating the shield stored within the visor pocket.

FIG. 15 is a cross-sectional view similar to FIG. 14 but illustrating the shield in its lowered, use, position extending beneath the visor.

FIG. 16 is a schematic, cross-sectional view illustrating the rays of a stop light passing through the curved strip formed on the upper portion of the shield and then the image visible to the driver's eyes.

### DETAILED DESCRIPTION

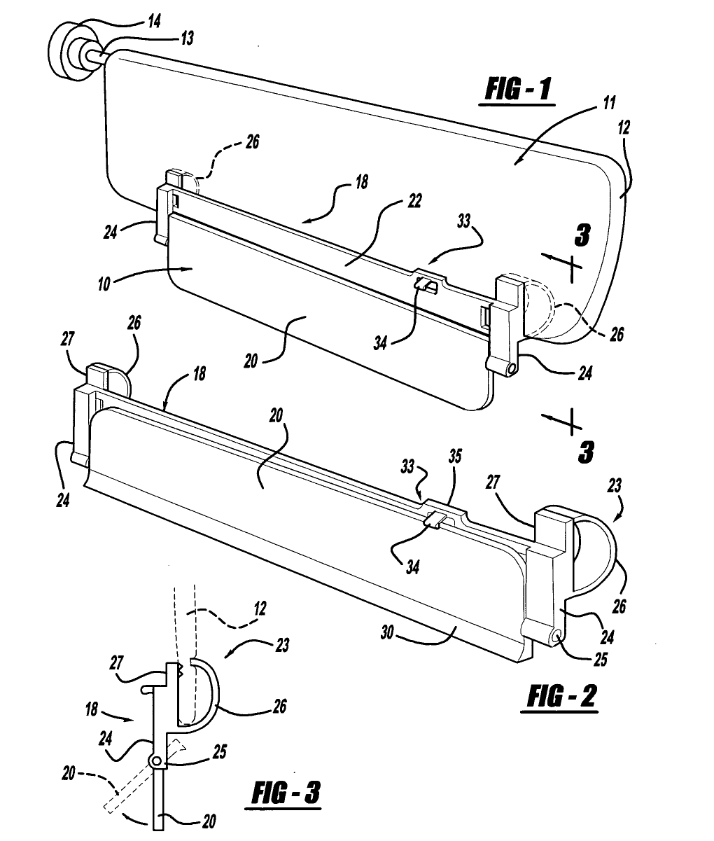

Referring to FIG. 1, the glare shield assembly 10 is detachably connected to the lower edge of a conventional automotive vehicle sun visor. In general, the visor comprises a flat panel which is horizontally elongated. The panel is supported upon a support rod 13 which is connected by a bracket 14 (shown schematically) to the vehicle body adjacent the windshield for positioning the visor in front of the driver of the vehicle. FIG. 1 illustrates the rear of the visor as seen by the driver of the vehicle.

A conventional sun visor arrangement allows the sun visor panel to pivot around a horizontal axis—e.g. the support rod—so that the visor is roughly parallel to the windshield and overlaps the upper portion of the windshield. In addition, the visor may be swung rearwardly of the vehicle to overlap the upper portion of the vehicle side window adjacent the driver. Similarly, the sun visor may be mounted at the passenger side of the vehicle with its bracket 14 connected to the side area adjacent the windshield for obscuring the upper portion of the windshield in front of the passenger.

The glare shield assembly 10 includes a horizontally elongated glare shield attachment bracket 18 upon which the glare shield 20 is pivotally attached. The glare shield is formed of conventional translucent, tinted, plastic material. Thus, the driver or passenger in the vehicle may look through the glare shield but the sunlight or glare would be substantially filtered out.

The glare shield attachment bracket 18 is formed with an elongated, flat, backing strip 22 having fastener clips formed on its opposite ends. Also, depending lugs 24 are formed on each of the opposite ends of the backing strip. The lugs are provided with socket holes 25.

The fastener clips on the ends of the backing strip are formed with curved, spring-like grip members 26 and a vertically upright back plate 27. The backing strip 22 with the elements set forth above, may be molded as a single unitary or integral construction. Alternatively, it may be fabricated out of separate pieces which are secured together by a suitable adhesive or by heat bonding or metallic fasteners or the like.

The springy fastener clips receive the edge portion of the sun visor as illustrated in FIG. 1. The curved grip members 26 grip the lower edge portion of the visor and resiliently hold it against the clip back plates 27. Thus, the bracket may be manually applied, quickly and easily and, conversely, manually removed by pulling the bracket from the sun visor. Teeth 28 formed on the clip back plates, or other roughening of the back plate surface, can assist in gripping the lower edge of the visor.

The glare shield 20 is provided with pivot pins 29 on its opposite ends. (See FIG. 4) The pins fit into the socket holes 25 in the bracket lugs 24. Hence, the shield may be pivoted, relative to the bracket, into a non-use position where it overlaps the flat backing strip 22 of the bracket, as illustrated in FIG. 2 or, it may be pivoted downwardly into a use position where it extends beneath the bracket backing strip. (See FIG. 1) When the shield is pivoted into its upward, storage position, it is held in place by a suitable latch 33. (See FIGS. 2 and 10) The latch includes a springy latch tongue 34 which slips over and frictionally holds the edge of the shield when the shield is pivoted into its upward, non-use position. Hence, when the user of the device manually pivots the shield into its upward position, the latch springs over the upper edge of the shield and temporarily holds it. For restoring the shield to its lowered, use position, the user may manually pull the shield to cause the latch to release its grip upon the shield. The latch may be provided with a tongue guard 35, illustrated in FIG. 2, for example, which forms a protective guard for the latch.

In operation, the user manually applies the attachment bracket 18 upon the lower edge of the sun visor which is located within the user's vehicle. Then, the shield may be manually pivoted upwardly into the position shown in FIG. 2 where it is latched into its non-use position. When bright sunlight or glare is encountered, the user may grasp the uppermost edge of the shield and pull it rearwardly, away from the bracket, so that it swings down into the position shown in FIG. 1. There the shield provides an extension beneath the sun visor to obstruct or filter out glare immediately beneath the visor.

The upper edge of the glare shield is formed with a concavely curved strip portion 30 which extends along substantially the entire length of the shield. The curved strip 30 serves to transmit and display an image of a traffic signal light located in front of the vehicle. Thus, it acts in a way similar to a prism. FIG. 11 schematically illustrates a stop light 40, which may have the traditional red, yellow and green lights or a turn arrow light, located in front of the vehicle. When the vehicle approaches or while the vehicle is waiting for the change in the signal light, the rays 41 of the light (shown schematically) pass through the curved upper edge of the shield and then provide an image that is visible to the eyes 42 of the user.

The curvature of the strip may be varied, to exhibit the stop lights when the visor is in a pre-determined range of distances from the lights. For example, the visibility range may be a distance of 5 meters to 40 meters at which time the light rays will pass through the upper edge of the visor and be visible to the viewer along the upper curved edge of the shield. The amount of curvature and the “window” within which the lights may be viewed, may be varied and may be determined by trial and error by one skilled in the art. Thus, the particular concave curvature that is selected will depend, in part, upon the thickness of the shield and the material out of which the shield is formed. The desired curvature may, upon suitable calculations and tryouts, be determined and then molded in the shield, or cut into the shield or, alternatively, applied as a separate tape-like strip that is molded with the desired curvature.

At times, the vehicle occupants may want to arrange the sun visor at an angle relative to the plane of the visor. Thus, the user may pivotally adjust the glare shield manually, relative to the visor, to provide protection against glare and to view the image of a traffic signal light where appropriate.

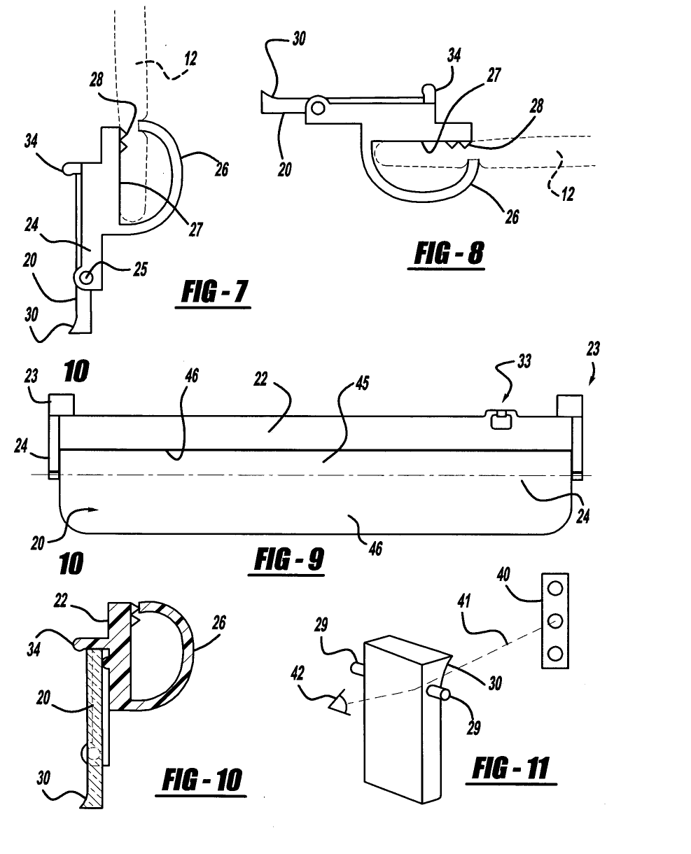

The pins 29 of the shield are arranged to extend horizontally outwardly relative to the vertical shield along an axis which is substantially closer to the upper edge of the shield than the lower edge of the shield. The terms upper and lower here refer to when the shield is arranged in a generally vertical plane. This axis of pivoting (see dotted line 44, in FIG. 9), also divides the shield into a relatively narrow, upper horizontal section 45 and a substantially wider, lower section 46. Thus, the narrow upper section 45 fills the space immediately beneath the lower edge 46 of the flat backing strip 22 of the bracket and between the lugs 24 of the bracket. This covers the gap which otherwise might appear between the upper edge of the shield and the lower edge of the bracket backing strip to block glare through that area. Meanwhile, the much wider lower portion 46 of the shield performs the glare obstruction beneath the visor lower edge.

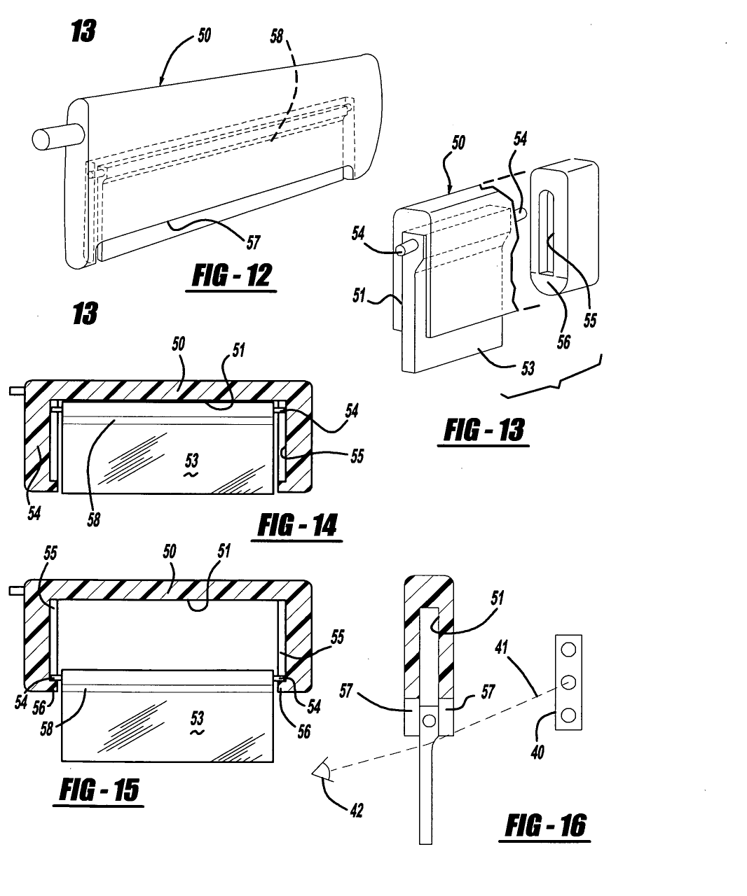

FIGS. 12-16 illustrate a modified assembly wherein the sun visor 50 is provided with an interior pocket or slot 51. The glare shield 53 fits within the pocket so that it may be substantially completely withdrawn or retracted within the sun visor or, alternatively, may be extended a substantial distance beneath the lower edge of the sun visor. The glare shield 53, when inserted within the pocket 51, is provided with pins 54 extending horizontally from its opposite edges. These pins fit into interior, side edge grooves 55 formed on the interior sides of the slot walls (see FIG. 13). The grooves terminate a short distance above the lower edge of the visor to form lugs or lower stops 56 about which the pins may pivot. In addition, a central portion of the lower part of the visor walls on the opposite faces of the visor, are cut away or relieved at 57 (see FIG. 12) to form the lower edge of the visor. The shield pins move downwardly within the grooves 55 until they reach the lower stops or lugs 56. Then the shield may be pivoted forwardly or rearwardly relative to the plane of the forward and rear faces of the sun visor 50.

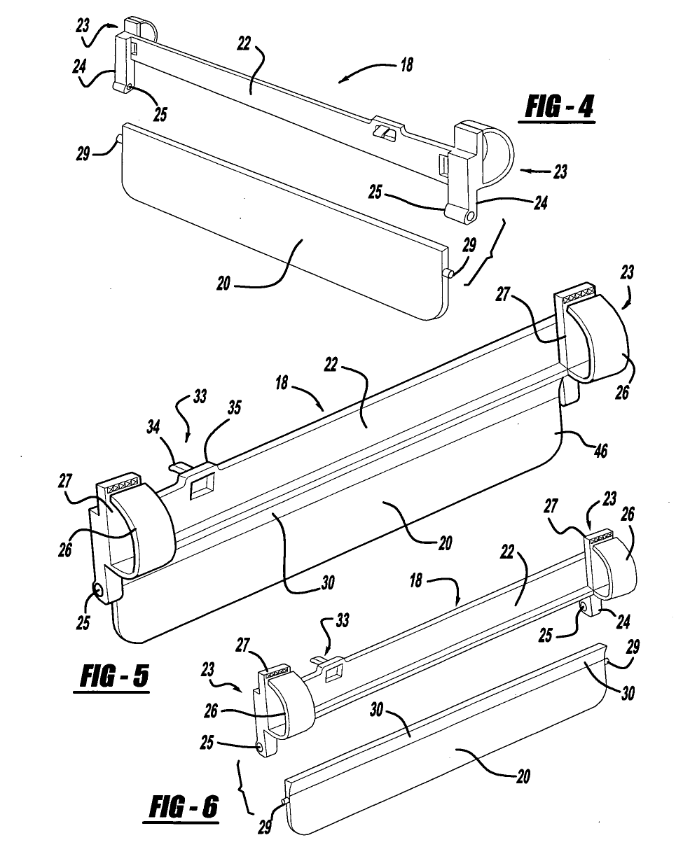

The glare shield 53, is provided with a concavely, curved-in-cross-section groove 58 along its upper edge and extending horizontally along its horizontal length. This groove, because of its curvature, operates similarly to the curved strip on the modification of FIGS. 1-10. The groove will receive rays of a traffic signal and display the image to the eye of the viewer within the vehicle (see FIG. 16). As in the case of the curved strip 30, the curvature of the curved groove 58 may be determined through trial and error, by a person skilled in the art, to receive and display images of traffic lights within a particular window of distances. Thus, the curvature of the groove may be varied, and will depend in part upon the material selected for the shield and the thickness of the shield. The groove may be cut or molded in the shield when the shield is manufactured.

The assembly described in the modification illustrated in FIGS. 12-16, would normally be used as original equipment in the manufacture of an automotive vehicle. However, such a combined visor and shield can be used as a replacement for an original equipment visor. The clip-mounted bracket construction of FIGS. 1-10 is suited for an after-market product which can be purchased by the vehicle user at a typical automotive supply store and manually applied by the user. The device of FIGS. 1-10 can easily be mounted on virtually any conventional sun visor and can be manufactured at low cost. Moreover, it can be used or stored on the visor or, alternatively, removed from the visor and kept elsewhere within the vehicle when glare protection is not needed.

This invention may be further developed within the scope of the following claims. Accordingly, having fully described at least one operative embodiment of this invention, it is now claimed.

1. A glare shield for attachment to an automotive vehicle sun visor formed of a horizontally elongated panel having a lower, generally horizontal edge comprising:
a flat, horizontally elongated, translucent, glare obstructing sheet;
horizontally axised pivot pins extending horizontally outwardly of the opposite ends of the sheet for pivotally connecting the sheet to the visor;
said pins having a common pivot axis which extends horizontally of the sheet to divide the sheet into an upper, narrow section which is integral with a lower, wide section; with the sheet being manually movable into a position wherein the wide section extends a distance beneath the visor lower edge for obstructing glare and being manually pivotable into angular positions relative to the plane of the visor panel; and the sheet being movable into a position in which its wide section substantially overlaps the visor panel;
whereby the shield may be optionally positioned by the user into a non-use position that overlaps the sun visor or into a use position in which it extends outwardly of the lower edge of the visor at a user-selected angle relative to the plane of the panel for unobstructed view through the sheet by the user.

2. A glare shield as defined in claim 1, and including a bracket for connecting the shield pivot pins to the sun visor; said bracket including a connector member having a horizontal bar of a length to overlap the visor along the lower edge of the visor; and a downwardly extending lug formed on the opposite ends of the bar, and each lug having a socket formed therein; each of said pivot pins extending into an adjacent lug socket to form a pivotal connection therewith at a distance beneath the lower edge of the visor panel whereby a horizontally extending space is formed between the pivotal axis of the pins and a lower edge of the bar; and said upper, narrow section of the sheet being of a width to substantially cover such space when the shield is moved into a use position in which the wide section of the shield extends downwardly relative to the visor panel lower edge.

3. A glare shield as defined in claim 1, and including a springy latch formed on said bar for engaging and holding the shield against movement relative to the bar when the shield is moved into a non-use position in which the shield wide portion overlaps and is substantially parallel to the plane of the bar.

4. A glare shield as defined in claim 2 and including springy clips formed on the opposite ends of the bar for engaging and resiliently grasping the lower edge portion of the visor for detachably connecting the glare shield to the visor.

5. A glare shield as defined in claim 1, and including a visor having a hollow pocket formed therein between the outer faces of the visor, and the pocket opening downwardly through the lower edge of the visor; guide grooves formed within the pocket along the opposite ends of the shields and receiving said pivot pins; and said visor being normally positioned within the pocket and being slideably held for moving downwardly and outwardly of the pocket for extending outwardly beneath the lower edge of the visor and, alternatively, slideably upwardly into the pocket for positioning the shield within the pocket; whereby the shield may be moved into a use position in which it extends downwardly and outwardly of the visor pocket and may be pivoted into desired angular positions relative to the visor.

6. A glare shield as defined in claim 5, and including an open channel formed in the shield and extending horizontally along the length of the shield; said channel being curved in transverse cross-section sufficiently to receive and display an image of a signal located at a pre-determined range of distances in front of the vehicle in which the glare shield and the visor are installed; whereby the user of the glare shield may view an image of a traffic signal light transmitted through the channel to the viewer located within the vehicle.

7. A glare shield for attachment to an automotive vehicle sun visor formed of a generally horizontally elongated panel having a lower, horizontal edge, comprising:
an attachment member for securing the glare shield to the lower edge portion of the sun visor panel, said glare shield being formed of a translucent, flat, horizontally elongated sheet divided into an upper, horizontally extending, narrow upper edge portion and an integral, horizontal, wide lower edge portion extending the width of the sheet and with the line dividing the portions forming a horizontal axis around which the sheet is pivoted;
pivot members secured to and extending horizontally outwardly of the sheet in alignment with said pivot line;
and said sheet being manually moveable to a non-use position in which it overlaps and is substantially parallel to the plane of the visor panel and, alternatively, into a second, use position in which it extends beneath the panel lower edge, with its line of pivoting located at a distance beneath the lower edge of the visor panel;
whereby, when the sheet is manually pivoted into a position wherein its wide portion extends beneath the panel for reducing glare; its narrow portion substantially covers a space formed between the lower edge of the visor and the line of pivoting for obstructing any glare through the space; and whereby the shield may be manually pivoted into desired angular relationship to the plane of the visor as desired by the user.

8. A glare shield as defined in claim 7, and including a support bracket having a pair of spaced-apart lugs which normally extend a distance beneath the sun visor lower edge; and said glare shield having laterally outwardly extending pivot pins aligned with said horizontal pivot axis; said pins extending into sockets formed in said lugs for pivotal connection to said lugs, whereby the panel may be manually pivoted relative to the bracket; and said bracket having connector members which detachably secure the bracket to the sun visor panel.

9. A glare shield as defined in claim 8, and said lugs extending beneath said sun visor lower edge to position said line of pivoting a short distance beneath the sun visor lower edge, thereby forming a space between the lower edge of the sun visor and the line of pivoting; with the narrow portion of the shield being of a size to substantially cover such space when the shield is pivoted into its use position with the wide portion thereof extending beneath the visor.

10. A glare shield as defined in claim 9, and said bracket having a generally horizontally elongated rigid strip arranged to overlap a lower edge portion of the visor, with said lugs being formed on opposite ends of the strip and extending beneath the lower edge of the strip for positioning the line of pivoting of the shield beneath, and spaced a short distance from, the lower edge of the visor, whereby the shield may be pivoted at angular locations relative to the plane of the visor.

11. A glare shield as defined in claim 9, and including a narrow, transversely curved in cross-section, strip formed along the upper edge of the shield on the shield face that is normally located nearest to the plane of the sun visor when the shield is moved into its use position, and with the strip being exposed beneath the sun visor lower edge; said curve strip being shaped for receiving the image of a traffic signal light located at a pre-determined distance in front of the vehicle within which the glare shield and sun visor are mounted and thereby displaying the image of the traffic signal to the user located in the vehicle in which the sun visor and glare shield are mounted.

12. A glare shield as defined in claim 10, and including a latch member formed on said strip for latching and temporarily holding an edge of said lower portion of the shield when the shield is arranged to overlap and is generally parallel to said strip in its non-use position.

13. A glare shield as defined in claim 7, and said sun visor panel having an interior pocket opening at its lower edge and of a size and shape for receiving the glare shield within the sun visor pocket; and with said glare shield being slideable into said pocket for non-use and downwardly out of said pocket for extending beneath the sun visor for use; and including pivot members extending sideways of said shield and fitted within grooves formed within the side edges defining the pocket for guiding the shield into and out of the pocket and for pivoting the shield relative to the plane of the visor when the shield extends downwardly and outwardly of the visor.

14. A glare shield system for attachment to a vehicle sun visor which is formed of a generally horizontally shaped panel having a normally horizontally elongated lower edge portion and being connected within a vehicle rearwardly of the vehicle windshield for use in shielding the driver or passenger of the vehicle from the glare of bright sunlight and of oncoming headlights, said glare shield comprising:
a generally flat, translucent sheet of a material for filtering and reducing glare;
a bracket attaching the sheet to the sun visor;
said sheet having its opposite ends pivotally connected to the bracket for pivoting the sheet into a first, glare screening position in which the sheet extends outwardly from the visor panel lower edge or alternatively, into a non-use position in which the sheet is generally moved parallel to, and overlaps, the lower edge portion of the panel;
said pivotal connections between the bracket and the sheet being located at a distance beneath the lower edge of the panel;
said pivotal connections having a pivot axis which divides the sheet into an upper, narrow portion and an integral wide lower portion, with the narrow portion being of a width to substantially cover a space formed between the lower edge of the visor panel and the line of pivoting which divides the sheet into its upper and lower portions, whereby the upper portion of the sheet will screen glare which otherwise would be visible through said space, when the sheet is arranged in its use position with its wide lower portion extending beneath the visor.

15. A glare shield system as defined in claim 14, and including a transversely curved, elongated edge band formed along the face of the shield which would normally be closest to the windshield of the vehicle, and along the upper edge of the shield, which is shaped to normally receive rays of light from traffic signals located at pre-determined distances in front of the vehicle and display images of said signals to the driver of the vehicle, when the shield is pivoted into its use position.

16. A glare shield system as defined in claim 15, and including said bracket comprising an elongated, flat strip normally positioned to overlap the lower edge portion of the visor; detachable connectors formed on the strip for manually connecting and disconnecting the bracket strip to the visor; and a pair of spaced-apart lugs formed on opposite ends of the strip and including pivotal sockets for receiving laterally-extending pivot pins formed on the opposite ends of the glare shield and positioned within the sockets for pivoting the glare shield relative to the bracket around the pivot line located beneath, and spaced downwardly, from the lower edge of the visor.
